(19) United States
(12) Patent Application Publication
(10) Pub. No.: US 2009/0200335 A1
(43) Pub. Date: Aug. 13, 2009

(54) Spray Device, Method for Spraying a Certain Quantity of Fluid and a Process for Manufacturing the Device

(76) Inventors: Billy Nilson, Mjolby (SE); Arne Eek, Trosa (SE)

Correspondence Address: VENABLE LLP, P.O. BOX 34385, WASHINGTON, DC, 20043-9998, US

(21) Appl. No.: 11/988,746

(22) PCT Filed: Jul. 5, 2006
(86) PCT No.: PCT/SE2006/000833

§ 371 Date: Feb. 19, 2009

(51) Int. Cl. B67D 5/64; G01F 11/00

(52) U.S. Cl. 222/162; 222/1

(57) ABSTRACT

A device and a method for spraying a certain quantity of fluid. The device includes a casing with a cavity for accommodating a liquid reservoir and a pump which delivers a specific quantity fluid upon activation. The device further includes a nozzle through which the flow of fluid passes in the form of spray droplets together with an activating device which acts upon the base of the reservoir due to the application of opposing forces to the casing, basically at right angles to the pumping movement of the device.

### TECHNICAL FIELD

The invention relates to a device which generally by means of manual actuation is intended to cause a liquid reservoir, provided with a pump or with a liquid under pressure, to perform a pumping movement so that a spray dose is released through a nozzle. The device is intended to improve the dosage accuracy and to facilitate the actual pumping. It may also be provided with a dose counter, which indicates the number of sprayed doses. The invention also relates to a method of using the device.

### BACKGROUND OF THE INVENTION

WO92/20455 shows an example of a spray device which is designed as a device for spraying a certain volume of liquid containing pharmaceutical preparations into a nasal cavity. This device also has a nozzle designed to reach into the nose. The pump part sprays through manual actuation, the force being applied largely in the same axial direction as the nozzle.

Such a device is capable of delivering a specific quantity of liquid but can be difficult to handle, since the axial movement may cause an unintentional movement of the nozzle inside the nasal cavity, which may interfere with the dosing or render it ineffective. The manual operation, which requires at least three fingers, one on the base part and one finger each on either side of the wing-like pump activator, is furthermore awkward. For users with small hands or with disabled hands, such as rheumatic sufferers, it may be difficult or downright impossible to perform such a pumping movement. For a person with thick fingers, a situation can arise in which he has difficulty in introducing the nozzle far enough into the nasal cavity, since his fingers may be in the way. There are quite clearly disadvantages with spray devices of this type.

### SUMMARY OF THE INVENTION

According to one aspect of the invention a device is disclosed having the characteristics of patent claim 1 attached.

According to a further aspect of the invention a method is disclosed having the characteristics of the independent method claim attached.

According to a further aspect of the invention a process is disclosed for manufacturing the device having the characteristics of the independent manufacturing process attached.

Further embodiments of the invention are set forth in the dependent patent claims.

According to the independent device claim, one aspect of the invention consists of a device for spraying a certain quantity of a fluid, the device comprising a casing and a nozzle for accommodating a liquid reservoir and a pump in a cavity in the casing, the casing containing an activating device which comprises two opposing lateral surfaces designed as squeeze surfaces in the lower part of the casing and at least one articulated link arm integrally formed with these lateral surfaces, said link arm being intended to be folded in towards a base of the liquid reservoir, when this has been inserted into the casing and received in the cavity, opposing forces P applied to the lateral surfaces being translated into an axial movement of the activating device, which pushes the pump against the nozzle and the casing, and the nozzle and the activating device furthermore being formed in one single piece.

The object of the present invention is to provide a spray device which eliminates or reduces the disadvantages hitherto inherent in known devices and which is easy for everybody to use, especially for those persons who have difficulties in performing the pumping movement that is required for activation of the spray device so that a spray dose is delivered.

The term pumping movement here equates a pump activating movement which pumps liquid from the liquid reservoir, with a valve activating movement, in which a pressurised liquid in the liquid reservoir delivers a spray dose. Similarly, the term pump in this description is equated with a valve, where the liquid reservoir contains a liquid which is subjected to a high pressure and where the valve, in a known manner, allows the liquid to flow out from the liquid reservoir via the valve.

Another object of the invention is to provide an improved manual pump in which the forces are primarily applied at right angles to the pumping direction and the nozzle and which is easier to manage since it is easier to handle, especially for persons with minor handicaps.

Another advantage of the device is that it can be designed to show the number of pump strokes, which are displayed, for example, in a small window in the casing, or in a slit.

A further advantage is that it is possible to adjust the stroke length of the pump if a change or reduction in the dosage is required.

The invention is characterised by its simplicity and its few parts.

The present invention therefore consists of a device for delivering a specific quantity of liquid in spray form and comprises a casing having an inlet for accommodating said liquid reservoir, which includes a pump, or alternatively a gas which exerts pressure on the liquid in the reservoir, and a nozzle through which, on activation, a flow passes in the form of spray droplets, together with an activating device, hereinafter referred to as the activator, which under the application of two opposing forces (P) basically at right angles to the direction of the nozzle is designed to move axially in the direction of the nozzle.

In a preferred embodiment the activator emerges from the casing.

In a preferred embodiment the casing on its outer wall has areas designed as squeeze surfaces. The directed forces must be applied against these squeeze surfaces.

The activator comprises an arrangement of the liquid reservoir enclosing it in the casing.

In a preferred embodiment the activator, which also comprises the enclosing, locking arrangement, has one or more suspension devices which serve as hinges and which in a preferred embodiment can be linked and interlocked at their free ends.

In a preferred embodiment the activator suspension devices are of elastically flexible design. When, in order to produce a pumping movement, a couple of forces (P) is applied to the casing, basically at right angles to said axial direction, the perpendicular movement is translated into an axial movement of the activator, which thereby pushes the pump (or the valve in the case of a pressurised liquid) towards the outlet of the casing, which consists of a nozzle.

In one embodiment the casing has a weakened surface in the material so that it can be squeezed together. In another preferred embodiment the casing has two opposing slits which extend from a lower edge of the casing upwards towards the top part, where the nozzle is situated, enough to facilitate squeezing together of the casing lateral surfaces between the slits during the pumping movement. The slits are located on the casing between the casing lateral surfaces.

In a preferred embodiment the liquid reservoir firstly comprises a reservoir for a liquid and secondly a pump, which pumps a certain volume of liquid from the reservoir through the nozzle, which is fixed in the upper part of—or integrated into—the casing.

In another embodiment the liquid reservoir comprises a pressurised reservoir containing liquid that is to be pumped, the aforementioned pump in this embodiment of necessity including the term valve, the valve in a known manner causing the liquid to flow through the valve when the valve is released by a movement which in the aforementioned embodiment is referred to as a pumping movement.

In a preferred embodiment the outlet of the casing is combined with a tubular part, which comprises the actual nozzle, in the duct of which there is a device for atomizing the liquid into a finely dispersed spray.

### BRIEF DESCRIPTION OF THE DRAWINGS

FIGS. 1a and 1b show perspective views of an alternative embodiment of the casing, without the liquid reservoir and the nozzle before the activator is fitted.

FIG. 1c shows a side view of the casing according to FIGS. 1a and 1b.

FIG. 1d is a sectional drawing along the line of section B-B in FIG. 1c.

FIGS. 2a and 2b show perspective views of a preferred embodiment of the casing with the activator folded in and fitted.

FIG. 2c shows a side view of the casing according to FIGS. 2a and 2b.

FIG. 2d shows a sectional drawing, along the line of section A-A in FIG. 2c, of the spray device which also contains a liquid reservoir.

FIG. 3a shows a preferred embodiment of the casing with nozzle in perspective with the link arms for the activator not fitted and with slits but without the liquid reservoir.

FIG. 3b shows the same as 3a but with the activator fitted.

FIG. 4 shows an embodiment with a casing designed as a frame with liquid reservoir fully exposed, although it is not shown in the drawing.

### DESCRIPTION OF A PREFERRED EMBODIMENT

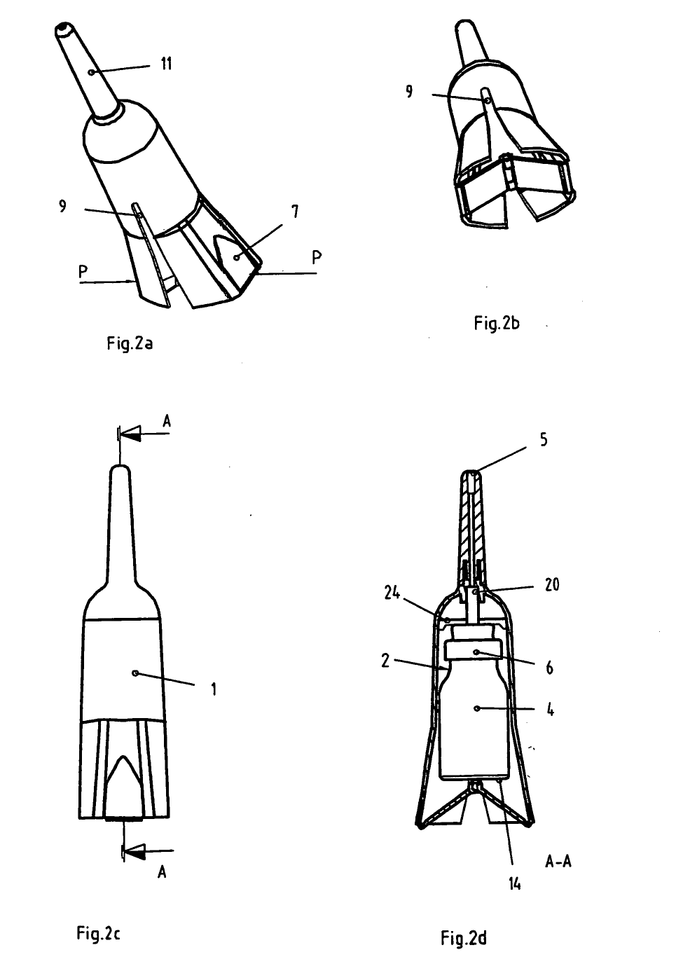

The spray device in FIGS. 2a -2d and 3a and 3b comprises a casing 1, made of plastics, such as polypropylene, for example, and is provided with a cavity 3 for containing a liquid reservoir 2 and an outlet 5 in the form of a nozzle, through which a dose, preferably of a liquid, is sprayed. FIGS. 2a till 2c show the casing 1 before the liquid reservoir 4 with the pump (or valve) 6 are fitted and FIG. 2d shows the spray device ready for use. The spray device also comprises the link arms 8a and 8b fitted together, referred to as the activator, for activating a dose from the liquid reservoir fitted in the casing.

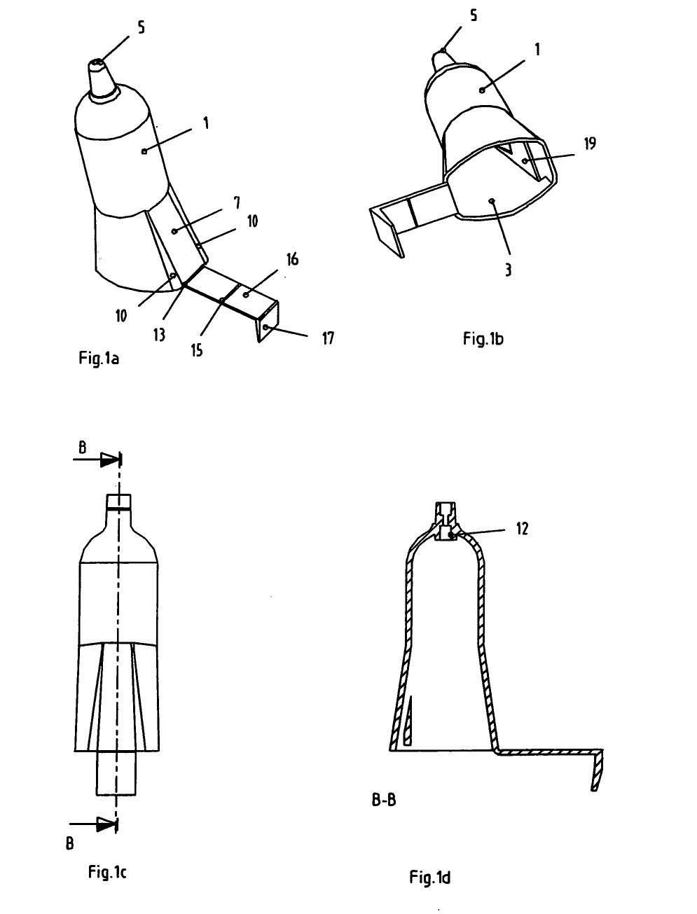

In the preferred embodiment in FIGS. 2a to 2d the casing 1 is usually a circular tubular section, which is slightly conical with the axis of the cone in the same direction as the nozzle, and the casing 1 therefore has a wide bottom part and a narrower top part, at the outlet. Viewed from above and in one part only, the casing comprises the nozzle 5, the casing 1 and link arms 8a and 8b. At least one lateral surface 7 is formed in the wall of the lower part of the casing as a squeeze surface. In a preferred embodiment, however, the casing is provided with a slit 9 and with two opposing lateral surfaces 7 which extend upwards for a distance in the casing and which are designed for secure manual pressing and hence for easy gripping of said squeeze surfaces. In order to allow the opposing sides to be pressed together when the casing is not provided with slits, the wall of the casing is made thinner at suitable points in this lower region, for example 10 in FIG. 1a.

The nozzle 5 emerges from the casing and may comprise a front part in a mouthpiece 11 and is preferably formed in one piece with the casing. The nozzle 5 is preferably foreshortened in order to reduce the residual quantities of the liquid in the nozzle 5 after use. On the inside of the casing is a tubular seat 12, in which the liquid reservoir 4 with associated pump (or valve) 6 is fitted. The activator is preferably made with the link arms 8a and 8b of equal length and each integrally formed with the casing 1, and also comprises the paired lateral surfaces 7 formed as squeeze surfaces. The link arms 8a and 8b, which once the liquid reservoir 2 has been fitted are first snapped together with the snap lock 18a and 18b, before being folded in with the aid of the reduced thickness of material 13 on either side, form an angle with one another and thereby further lock the liquid reservoir firmly against its base 14, so that it cannot fall out of the casing. The spray device is now ready for use.

In an alternative embodiment shown in FIGS. 1a to 1d, the link arms are instead formed as one arm 16 and this is suitably bent in order to hold the liquid reservoir 2 fast (the liquid reservoir here includes a pump or valve), following which the arm itself is locked with the part 17 in the dip 19. In order to be able to fold the arm 16 it is provided with weakened sections in the material at the points marked by 13 and 15, and for looking some form of catch on the part 17 in the material. Where the activator is designed with only one link arm the function is still the same as in the embodiment having two link arms 8a, 8b, since in both cases a link part is connected to each lateral surface respectively in the finished spray device, two link parts being coupled together to form a joint, which beams on the base of the liquid reservoir 4. In the case of two link arms 8a, 8b each link arm forms a link part, whereas in the case of just one link arm 16 two link parts are already coupled together by the articulation, which will form said joint.

FIG. 2d shows the spray device in its entirety in a cross sectional drawing, with the liquid reservoir 2 comprising a liquid reservoir 4, preferably a phial, and a manually activated pump 6, which is fixed to the phial and which delivers a specific dose upon activation. The liquid reservoir 2 is fitted in the casing 1 in the cavity 3.

Where a liquid propelling device in the form of a pump 6 is used to deliver liquid from the liquid reservoir 4, the pump 6 comprises a pump body, not shown, and a tubular part 20 which is inserted into the lower/inner part of the nozzle 5 in a recess 12, which is indicated in FIG. 1d. Extending outwards from the casing 1 in an axial direction is the nozzle 5, through which the intended dose is sprayed when the tubular part 20 is pressed into the pump. In practice this means that the liquid reservoir 4 is pressed upwards by the activator, thereby pressing the tubular part 20 in, since the upper part of the pump/the valve 6 bears on a stop 24, which forms the front wall in the cavity 3, when the forces P compress the surfaces 7 towards one another.

Where a liquid propelling device in the form of a pressurised gas inside the liquid reservoir 4 is used to deliver liquid from the liquid reservoir 4, the pump 6 consists of a valve which is opened, so that the gas expels liquid from the liquid reservoir 4 via the valve to an outlet in the form of the tubular part 20. In practice this means that the liquid reservoir 4 is pressed upwards by the activator (which is operated by a user), thereby pressing the tubular part 20 in towards the liquid reservoir 4 and releasing/opening the valve, when the forces P compress the surfaces 7 towards one another.

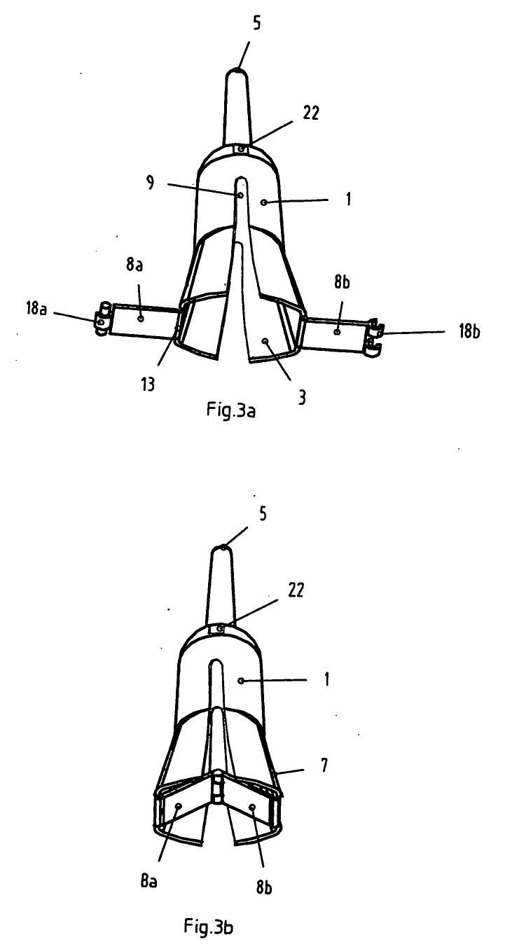

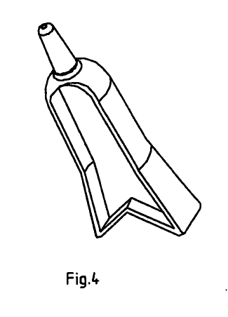

FIGS. 3a and 3b show the casing 1 with the link arms 8a and 8b firstly folded out in 3a and then fitted with the snap locks 18a and 18b locked, but without the liquid reservoir 2. A window 22 for displaying the number of pumped doses is also shown.

In order to reduce the residual quantity of liquid in the pump and nozzle, the nozzle is foreshortened and a packing body is inserted, which fills up the tubular part 20 of the pump without significantly obstructing the flow.

As stated, the spray device can also be used to accommodate a liquid reservoir 4, which contains a propellant gas, that is to say a so-called aerosol container.

In order to dispense a spray giving a specific dose, a force P is applied to the opposing lateral surfaces 7, both of the link arms 8a, 8b of the activator (or both of the link parts in the link arm 16), which inwards towards the base of the liquid reservoir form a joint, penetrating further inwards towards the base of the liquid reservoir and thereby pressing the liquid reservoir 4 inwards in the spray device, the slit 9 considerably facilitating such a movement. This lifting movement activates the pump the valve 6, which then expels the intended quantity of liquid through the nozzle, in which an atomizing device atomizes the liquid to form a spray cloud.

Alternative embodiments, such as an ellipsoid or spherical shape of the casing, for example, or a single lateral surface 7 against a fixed part, are feasible. In another example the casing is designed with a frame-like strip of approximately the same width as the link arms 8a and 8b, which can be said to form an extension of these around the liquid reservoir and with the nozzle uppermost, that is to say a more open embodiment of the invention. This embodiment makes it possible to see the contents of the liquid reservoir 4, and with a graduation of this it is possible to calculate the number of doses.

Alternatively the casing can be designed with a wall which has a frame or lattice structure. Such an embodiment of the casing affords the advantage that the liquid reservoir accommodated in the casing can easily be identified by a user, so that he can readily ascertain which type of pharmaceutical preparation or the like is contained in the casing. This advantage can naturally also be achieved by the use of a transparent plastic material for the casing 1.

### Definition

The term pump is intended to include any type of liquid-propelling device.

The verb to pump is intended to relate to a measure for activating the liquid-propelling device. The verb to pump is therefore also intended to include a simple movement for opening a valve in which a propellant gas forces liquid through the valve.
The pumping movement is intended to relate to a movement which an operator performs on the device in order to activate the pump/the valve.

1. A device for spraying a certain quantity of a fluid, the device comprising
a casing and a nozzle for accommodating a liquid reservoir and a pump in a cavity in the casing, wherein the casing comprises an activating device comprising two opposing lateral surfaces designed as squeeze surfaces in the lower part of the casing and at least one articulated link arm integrally formed with these lateral surfaces, said link arm being intended to be folded in towards the base of the liquid reservoir, when the liquid reservoir has been inserted into the casing and accommodated in the cavity, opposing forces applied to the lateral surfaces being translated into an axial movement of the activating device which pushes the pump against the nozzle, and the casing, the nozzle and the activating device being formed in one piece.

2. The device according to claim 1, wherein the link arms of the activating device are designed to lock the entrance to the cavity in the casing.

3. The device according to claim 1, wherein slits on opposite sides of the casing weaken this and facilitate the pumping movement by reducing the forces required.

4. The device according to claim 1, wherein the activating device has one or two folding link arms fixed to the casing.

5. The device according to claim 1, wherein the link arms or of the activating device have weakened sections at the folding points.

6. The device according to claim 2, wherein a single folding link arm of the activating device fixed to the casing on a first lateral surface has a fastening device so that the free end thereof can be fixed in a clip on a second lateral surface.

7. The device according to claim 3, wherein the folding link arms of the activating device fixed to the casing on the respective lateral surface are fastened together by means of snap hinge attachments to form a common moveable double arm.

8. The device according to claim 1, wherein the casing is designed as a frame or lattice-like device around the reservoir.

9. The device according to claim 1, wherein the casing is provided with a numeral window for reading off a counter which indicates the number of doses dispensed.

10. A method for spraying a certain dose of a fluid from a liquid reservoir with an associated pump, the method comprising:
providing a casing which has a nozzle integrally formed with the casing and an associated cavity,
inserting the liquid reservoir with the pump into said cavity,
applying opposing forces to the outside of the casing on two opposing lateral surfaces designed as squeeze surfaces in the lower part of the casing,
joining a link part in at least one link arm to each lateral surface and joining the link parts together to form a joint which bears against the base of the liquid reservoir, and
translating the opposing forces by the link parts into a force which with said joint is imparted to the base of the liquid reservoir, thereby activating the pump to release a fluid, which is made to flow through the nozzle so that a dose of the fluid is sprayed through the nozzle.

11. A process for manufacturing a device according to claim 1, wherein the spray device is made of plastics, the process comprising:
forming the casing, the nozzle and the activating device in one single piece.
